(19) United States
(12) Patent Application Publication
(10) Pub. No.: US 2010/0250148 A1
(43) Pub. Date: Sep. 30, 2010

(54) DETERMINISTIC NDE SYSTEM AND METHOD FOR COMPOSITE DAMAGE ASSESSMENT AND REPAIR

(75) Inventors: Kimberly D. Meredith, Seattle, WA (US); Michael J. Graves, Seattle, IL (US); Gary E. Georgeson, Federal Way, WA (US); Russell L. Keller, Maple Valley, WA (US); Everett A. Westerman, Auburn, WA (US)

Correspondence Address: TUNG & ASSOCIATES;Suite 120, 838 W. Long Lake Road, Bloomfield Hills, MI, 48302, US

(73) Assignee: The Boeing Company

(21) Appl. No.: 12/410,838

(22) Filed: Mar. 25, 2009

(51) Int. Cl. G06F 19/00; G01M 5/00

(52) U.S. Cl. 702/34; 73/802

(57) ABSTRACT

A deterministic non-destructive evaluation system for composite damage assessment and repair includes structure of interest, non-destructive evaluation data and strength test data obtained on the structure of interest, finite element analysis performed on a structural model modified by the non-destructive data and the strength test data, a strength-to-indication correlation based on the finite element analysis and deterministic non-destructive evaluation predictions and recommendations based on the strength-to-indication correlation.

### TECHNICAL FIELD

The present disclosure is generally directed to NDE (non-destructive evaluation) methods for assessment and repair of damage to composite structures. More particularly, the present disclosure is generally directed to a deterministic NDE approach which utilizes direct qualitative non-destructive damage and degradation input to structural models for engineering-based performance prediction.

### BACKGROUND

Current NDE of damage and repairs to composite materials includes many techniques including ultrasonic, optical and visual methods for certification. The evaluations may be carried out on the factory floor and in field inspection to evaluate the soundness of just-manufactured structures as well as any damage that occurs during aircraft build and field usage.

Current NDE approaches may involve historical and conservative accept/reject criteria and may be found in Structural Repair Manuals and in other governing documents. However, the accept/reject criteria used in current NDE approaches may not be based on direct correlation of defect/indication to strength or the existing life of the structure. Consequently, the criteria may translate directly to escapements and false calls; may lead to the conservative repair approach which may require that a scratch be treated the same as a thru-hole in the structure; and may lead to the repair of structures that do not require repair or to the over-designing of repairs. Once repaired, small defects or porosity in a repair may require a structurally safe repair to be removed and re-done at great cost in time and money.

Therefore, composite rapid repair assessment and verification methodologies are needed for composite aircraft and other composite structures.

### SUMMARY

The present disclosure is generally directed to a deterministic non-destructive evaluation system for composite damage assessment and repair. An illustrative embodiment of the system includes a structure of interest, non-destructive evaluation data and strength test data obtained on the structure of interest, finite element analysis performed on a structural model modified by the non-destructive data and the strength test data, a strength-to-indication correlation based on the finite element analysis and deterministic non-destructive evaluation predictions and recommendations based on the strength-to-indication correlation.

The present disclosure is further generally directed to a deterministic non-destructive evaluation method for composite damage assessment and repair. An illustrative embodiment of the method includes providing a structure, generating non-destructive evaluation data of the structure, generating strength-to-indication correlations and deterministic non-destructive evaluation results based on finite element analysis performed on a structural model modified by the non-destructive evaluation data and recommending a move-forward response based on the strength-to-indication correlations and deterministic non-destructive evaluation results.

The present disclosure is further generally directed to a deterministic non-destructive evaluation method for composite damage assessment and repair. An illustrative embodiment of the method includes providing a structure, generating non-destructive evaluation data of the structure, analyzing the non-destructive evaluation data of the structure, generating mechanical data by performing mechanical testing on the structure, performing finite element analysis on a structural model modified by the non-destructive evaluation data and the mechanical data, generating strength-to-indication correlations and deterministic non-destructive evaluation results based on the finite element analysis, inputting the strength-to-indication correlations and deterministic non-destructive evaluation results to input analysis tools and recommending a move-forward response based on the strength-to-indication correlations and deterministic non-destructive evaluation results.

The present disclosure is further generally directed to a deterministic non-destructive evaluation system for composite damage assessment and repair. An illustrative embodiment of the system includes a composite structure of interest; non-destructive evaluation data obtained by at least one of optical methods; ultrasonic methods and visual methods; strength test data obtained on the structure of interest by mechanical testing of the structure of interest; finite element analysis performed on a structural model modified by the non-destructive data and the strength test data; a strength-to-indication correlation based on the finite element analysis; and deterministic non-destructive evaluation predictions and recommendations based on the strength-to-indication correlation obtained using programmed correlations and a non-destructive evaluation analytical look-up table, a strength/load-carrying capacity-indication look-up table and a safety standards look-up table.

The present disclosure is further generally directed to a deterministic non-destructive evaluation method for composite damage assessment and repair. An illustrative embodiment of the method includes providing a composite structure; generating non-destructive evaluation data of the composite structure by at least one of ultrasonic methods, optical methods and visual methods; analyzing the non-destructive evaluation data of the composite structure; generating mechanical data by performing mechanical testing on the composite structure; performing finite element analysis on a structural model modified by the non-destructive evaluation data and the mechanical data; generating strength-to-indication correlations and deterministic non-destructive evaluation results based on the finite element analysis using a non-destructive evaluation analytical look-up table, a strength/load-carrying capacity-indication look-up table and a safety standards look-up table; inputting the strength-to-indication correlations and deterministic non-destructive evaluation results to input analysis tools; and recommending a move-forward response with respect to damage of the structure based on the strength-to-indication correlations and deterministic non-destructive evaluation results.

### BRIEF DESCRIPTION OF THE ILLUSTRATIONS

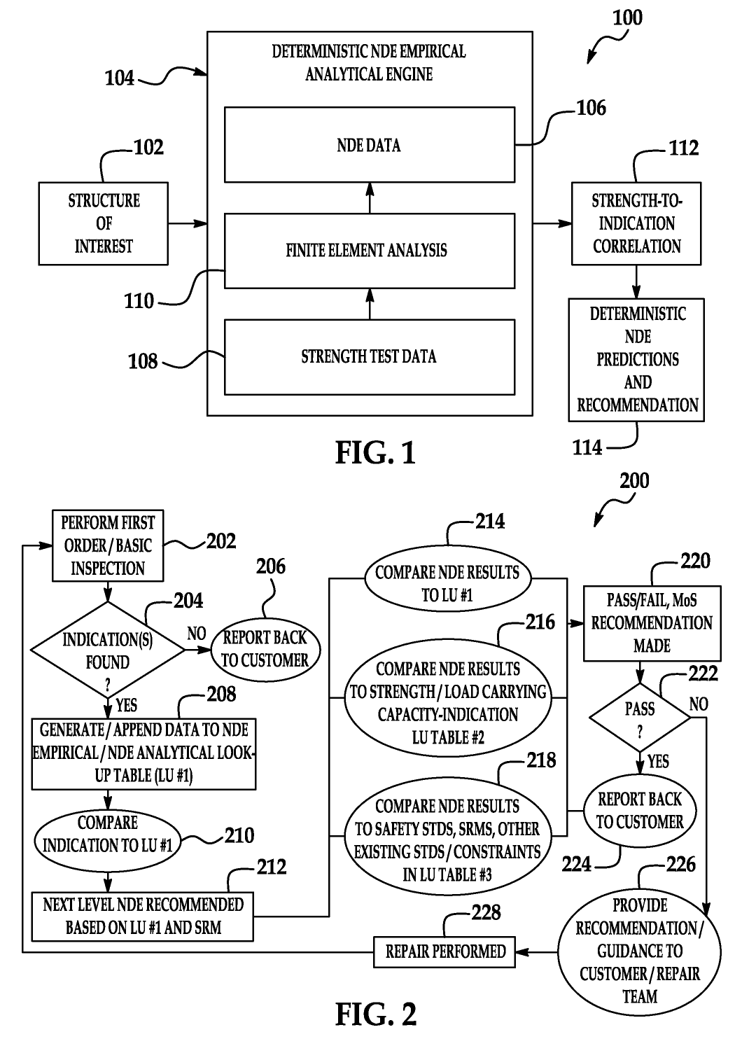

FIG. 1 is a block diagram which illustrates an illustrative embodiment of the deterministic NDE system for composite damage assessment and repair.

FIG. 2 is a flow diagram which illustrates transformation of NDE data into performance data according to an illustrative embodiment of the deterministic NDE method for composite damage assessment and repair.

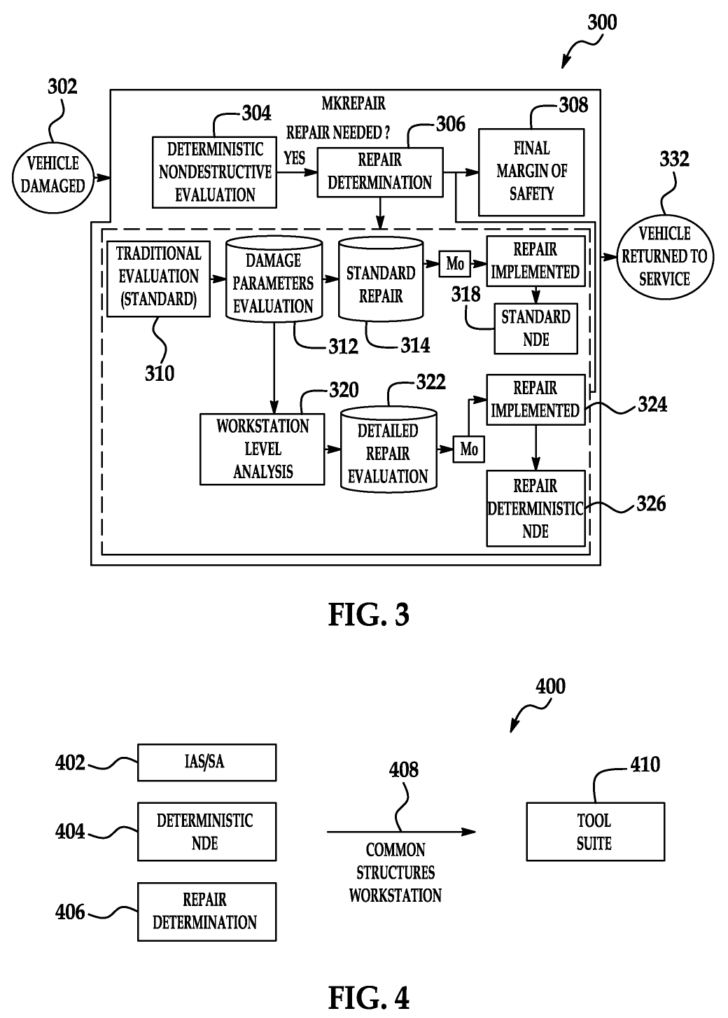

FIG. 3 is a flow diagram which illustrates the relationship between deterministic NDE and repair determinations and the general flow of repair according to an illustrative embodiment of the deterministic NDE method for composite damage assessment and repair.

FIG. 4 is a block diagram which illustrates an illustrative embodiment of the deterministic NDE system for composite damage assessment and repair as a component part of a suite of tools.

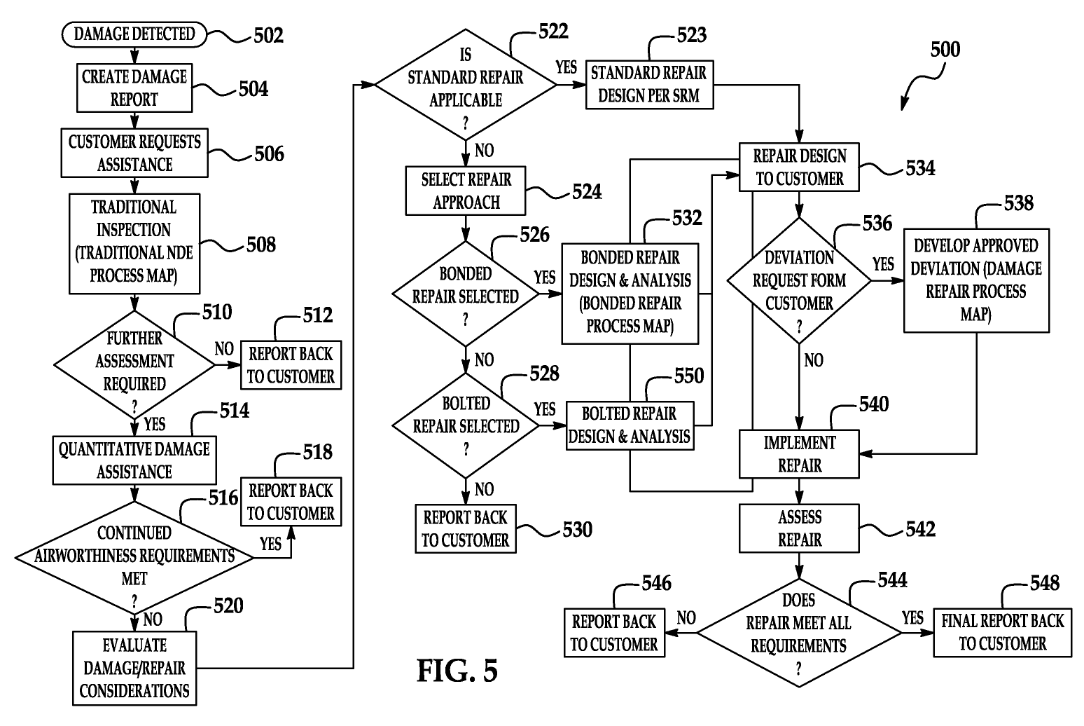

FIG. 5 is a flow diagram which illustrates an aircraft composite structural damage and repair lifecycle in implementation of an illustrative embodiment of the deterministic NDE method for composite damage assessment and repair.

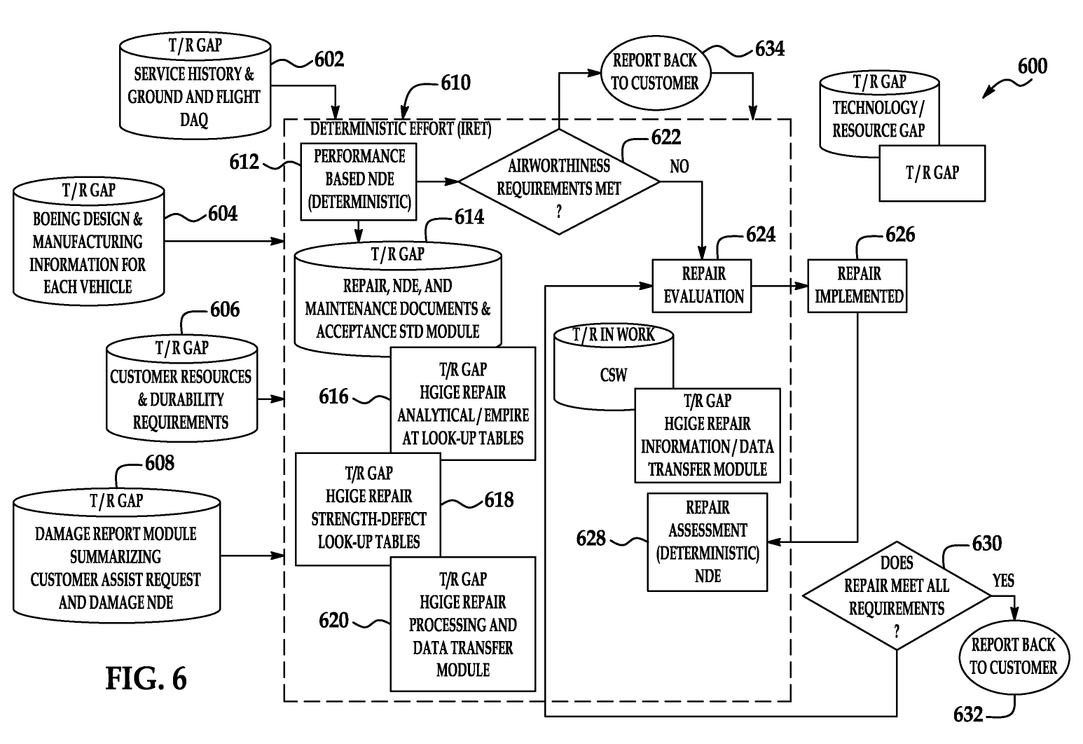

FIG. 6 is a block diagram which illustrates technical elements used in implementation of an illustrative embodiment of the deterministic NDE system for composite damage assessment and repair.

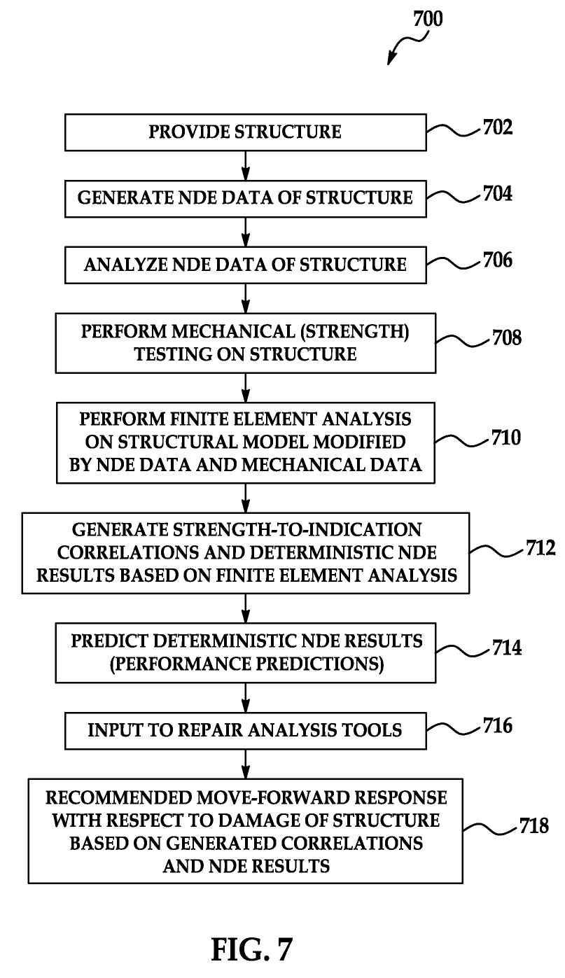

FIG. 7 is a flow diagram which summarizes an illustrative embodiment of the deterministic NDE method for composite damage assessment and repair.

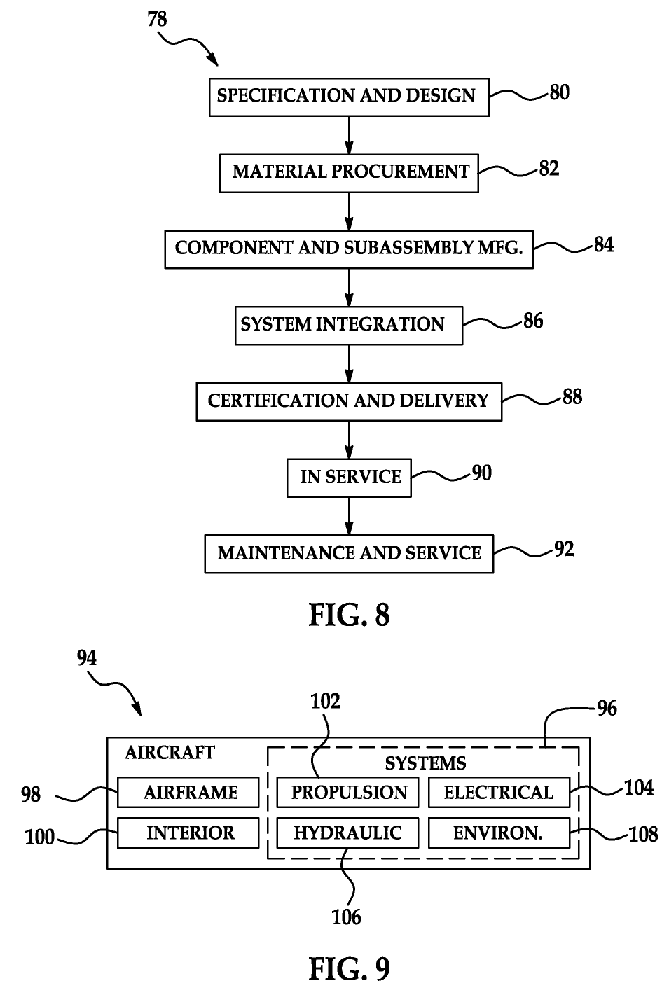

FIG. 8 is a flow diagram of an aircraft production and service methodology.

FIG. 9 is a block diagram of an aircraft.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, brief summary or the following detailed description.

Referring initially to FIG. 1, a block diagram 100 which illustrates an illustrative embodiment of the deterministic NDE system for composite damage assessment and repair, hereinafter system, is shown. The system 100 may include a structure of interest 102 which in some embodiments may be a composite structure. A deterministic NDE empirical-analytical engine 104 may include quantitative NDE (non-destructive evaluation) data 106 which may be obtained by non-destructive evaluation of the structure of interest 102 and strength test data 108 which may be obtained by mechanical testing of the structure of interest 102. A finite element analysis 110 of damage and repairs to the structure of interest 102 may be performed on a structural model which is modified by the NDE data 106 and the strength test data 108. Based on the finite element analysis 110, a strength-to-indication correlation 112 which correlates the NDE data 106 to the strength test data 108 may be obtained using programmed correlations and look-up tables. Deterministic NDE predictions and recommendations 114 as to whether to repair the structure of interest 102, as well as the type of repair to be made to the structure of interest 102, may be based on the strength-to-indication correlation 112 and provided as input to repair analysis tools.

Referring next to FIG. 2, a flow diagram 200 which illustrates transformation of NDE data into performance data according to an illustrative embodiment of the deterministic NDE method for composite damage assessment and repair, hereinafter method, is shown. In block 202, a basic inspection of a structure of interest, which in some applications may be a composite structure, may be performed using non-destructive evaluation (NDE) techniques known to those skilled in the art. The NDE techniques may include ultrasonic, optical and/or visual methods to determine an indication of damage to the structure of interest. In block 204, a determination may be made as to whether an indication of damage to the structure of interest was found based on the results of the NDE techniques (NDE results) in block 202. In the event that the NDE results do not reveal an indication of damage to the structure of interest, such may be reported back to a customer who ordered the inspection of the structure of interest in block 206. In the event that the NDE results do reveal an indication of damage to the structure of interest, data relating to the indication of damage may be generated or appended to an NDE empirical/NDE analytical look-up table in block 208. The NDE results may include the NDE defined geometry, location, orientation and property degradation related to the damage of the structure of interest. In block 210, the indication of damage may be compared to the data in the NDE empirical/NDE analytical lookup table of block 208. In block 212, a next level of response may be made based on the comparison of the indication of damage to the data in the NDE empirical/NDE analytical lookup table in block 210.

In block 214, the NDE results obtained in block 202 may be compared to the data in the NDE empirical/NDE analytical look-up table of block 208. In block 216, the NDE results may be compared to data in a strength/load carrying capacity-indication lookup table. In block 218, the NDE results may be compared to safety standards, SRMs, other existing standards and/or constraints data in a standards lookup table. In block 220, based on the comparisons carried out in blocks 214, 216 and 218, a pass/fail determination with margin of safety recommendation for further action may be made. In block 222, a determination may be made as to whether repairs to the structure of interest must be made. In the event that the structure of interest does not require repair and therefore passes the pass/fail determination in block 222, such may be reported back to the customer in block 224. In the event that the structure of interest does require repair and therefore does not pass the pass/fail determination in block 222, recommendation and/or guidance to a customer/repair team may be made in block 226. A repair may be made to the structure of interest in block 228. The method may then return to basic inspection of the structure of interest in block 202, after which the process may be repeated until the structure of interest does not require repair and thus passes the pass/fail inquiry posed in block 222. Accordingly, deterministic NDE may be used after repair of the structure of interest in block 228 as needed to provide quantitative prediction of the performance of the repair made in block 228.

Referring next to FIG. 3, a flow diagram 300 which illustrates the relationship between deterministic NDE and repair determinations and the general flow of repair according to an illustrative embodiment of the method is shown. In block 302, a vehicle may be damaged. In block 304, a deterministic nondestructive evaluation (NDE) of the damage to the vehicle may be made. In block 306, a repair determination may be made. In block 308, a final margin of safety may be determined based on the repair determination made in block 306.

The repair determination in block 306 may be initiated using a standard or traditional evaluation approach in block 310. In block 312, a damage parameters evaluation may be made using NDE analysis to determine the nature and extent of the damage to the vehicle. In block 314, a standard repair to the vehicle may be formulated. In block 316, the proposed repair to the vehicle may be implemented. In block 318, a standard NDE may be performed after repair of the vehicle.

In some applications, a workstation level analysis may be made in block 320 after the NDE damage parameters evaluation is carried out in block 312. In block 322, a detailed repair evaluation may be made. In block 324, a repair of the vehicle may be implemented. In block 326, a repair deterministic NDE may be performed after the repair is carried out in block 324.

Referring next to FIG. 4, a block diagram 400 which illustrates an illustrative embodiment of the deterministic NDE system for composite damage assessment and repair as a component part of a suite of tools 410 is shown. The system 400 may include an Integrated Analysis System/Section Analysis (IAS/SA) 402, a deterministic NDE 404 and a repair determination 406 which may be included as part of a suite of tools 410 in a common structures workstation 408.

Referring next to FIG. 5, a flow diagram 500 which illustrates an aircraft composite structural damage and repair lifecycle in implementation of an illustrative embodiment of the method is shown. In block 502, damage to a structure of interest may be detected. In block 504, a damage report may be created. In block 506, a customer which ordered the damage report may request assistance. In block 508, traditional inspection on the structure of interest may be carried out using NDE techniques. In block 510, a determination may be made as to whether further damage assessment of the structure of interest is required. If no further damage assessment of the structure of interest is required in block 510, such may be reported back to the customer in block 512. If further damage assessment of the structure of interest is required, quantitative damage assessment of the structure of interest may be made in block 514. In block 516, a determination may be made as to whether an aircraft having the structure of interest meets continued airworthiness requirements. If yes, then such may be reported back to the customer in block 518. If no, then damage/repair considerations may be evaluated in block 520.

In block 522, a determination may be made as to whether standard repair techniques to the structure of interest are applicable based on the evaluation carried out in block 520. If standard repair techniques are not applicable, then the appropriate repair approach may be selected in block 524. These may include selection of a bonded repair technique in block 526 or selection of a bolted repair technique in block 528. If neither a bonded repair technique is selected in block 526 nor a bolted repair technique is selected in block 528, such may be reported back to the customer in block 530.

If a bonded repair technique is selected in block 526, bonded repair design and analysis may be carried out in block 532. A repair design may be made to the customer in block 534. In block 536, a determination may be made as to whether a deviation request was received from the customer. If yes, then an approved deviation may be developed in block 538. If no, then the bonded repair to the part may be implemented in block 540. In block 542, the repair implemented in block 540 may be assessed. In block 544, a determination may be made as to whether the repair meets all requirements. If no, then such may be reported back to the customer in block 546. If yes, then such may be reported back to the customer in block 548.

If a bonded repair technique is not selected in block 526, then a bolted repair technique may be selected in block 528. A bolted repair design and analysis may be carried out in block 550. A repair design may be made to the customer in block 534. In block 536, a determination may be made as to whether a deviation request was received from the customer. If yes, then an approved deviation may be developed in block 538. If no, then the bonded repair to the part may be implemented in block 540. In block 542, the repair implemented in block 540 may be assessed. In block 544, a determination may be made as to whether the repair meets all requirements. If no, then such may be reported back to the customer in block 546. If yes, then such may be reported back to the customer in block 548.

Referring next to FIG. 6, a flow diagram 600 which illustrates technical elements used in implementation of an illustrative embodiment of the system is shown. Block 602 may include a service history, ground and flight information and/or other information of an aircraft or other vehicle. Block 604 may include design and manufacturing information for each vehicle. The design and manufacturing information may include aircraft design and drawing information, manufacturing and assembly information, NDE/rework information and/or test flight information, for example and without limitation. Block 606 may include customer resources and durability requirements which may include customer inspection and repair resources, age of the aircraft, service life of the aircraft and/or customer's preferred level of effort (HGIGE) definition, for example and without limitation. Block 608 may include a damage report module which summarizes customer assist request and damage NDE information. The damage NDE information may include NDE and strength-based performance results and/or traditional inspection results (qualitative experience-based interpretation), for example and without limitation.

The data in blocks 602, 604, 606 and 608 may be provided to a deterministic effort (IRET) component 610. The deterministic effort 610 may include a performance-based deterministic NDE component 612. The performance-based deterministic NDE component 612 may include repair, NDE and maintenance documents and an acceptance standard module 614; analytical/empirical lookup tables 616; strength-defect lookup tables 618; and a processing and data transfer module 620.

In block 622, a determination may be made as to whether airworthiness requirements of the aircraft have been met based on the results of the performance-based deterministic NDE component in block 612. If yes, then such may be reported back to the customer in block 634. If no, then a repair evaluation may be made in block 624. A repair may be implemented in block 626. A repair assessment deterministic NDE may be made in block 628. In block 630, a determination may be made as to whether the repair meets all requirements. If yes, then such may be reported back to the customer in block 632.

Referring next to FIG. 7, a flow diagram 700 which summarizes an illustrative embodiment of the method is shown. In block 702, a structure is provided. In block 704, NDE data of the structure is generated. In block 706, the NDE data of the structure which was obtained in block 704 is analyzed. In block 708, mechanical (strength) testing of the structure is performed. In block 710, finite element analysis of a structural model modified by the NDE data and the mechanical data is performed. In block 712, strength-to-indication correlations and deterministic NDE results based on the finite element analysis is made. In block 714, deterministic NDE results (performance predictions) are predicted. In block 716, the deterministic NDE result predictions made in block 714 are inputted to repair analysis tools. In block 718, a move-forward response with respect to damage of the structure based on the generated correlations and NDE data results is made.

Referring next to FIGS. 8 and 9, embodiments of the disclosure may be used in the context of an aircraft manufacturing and service method 78 as shown in FIG. 8 and an aircraft 94 as shown in FIG. 9. During pre-production, exemplary method 78 may include specification and design 80 of the aircraft 94 and material procurement 82. During production, component and subassembly manufacturing 84 and system integration 86 of the aircraft 94 takes place. Thereafter, the aircraft 94 may go through certification and delivery 88 in order to be placed in service 90. While in service by a customer, the aircraft 94 may be scheduled for routine maintenance and service 92 (which may also include modification, reconfiguration, refurbishment, and so on).

Each of the processes of method 78 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 9, the aircraft 94 produced by exemplary method 78 may include an airframe 98 with a plurality of systems 96 and an interior 100. Examples of high-level systems 96 include one or more of a propulsion system 102, an electrical system 104, a hydraulic system 106, and an environmental system 108. Any number of other systems may be included. Although an aerospace example is shown, the principles of the disclosure may be applied to other industries, such as the automotive industry.

The apparatus embodied herein may be employed during any one or more of the stages of the production and service method 78. For example, components or subassemblies corresponding to production process 84 may be fabricated or manufactured in a manner similar to components or subassemblies produced while the aircraft 94 is in service. Also one or more apparatus embodiments may be utilized during the production stages 84 and 86, for example, by substantially expediting assembly of or reducing the cost of an aircraft 94. Similarly, one or more apparatus embodiments may be utilized while the aircraft 94 is in service, for example and without limitation, to maintenance and service 92.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A deterministic non-destructive evaluation system for composite damage assessment and repair, comprising:
a structure of interest;
non-destructive evaluation data and strength test data obtained on said structure of interest;
finite element analysis performed on a structural model modified by said non-destructive data and said strength test data;
a strength-to-indication correlation based on said finite element analysis; and
deterministic non-destructive evaluation predictions and recommendations based on said strength-to-indication correlation.

2. The system of claim 1 wherein said non-destructive evaluation data comprises non-destructive evaluation data obtained by ultrasonic methods.

3. The system of claim 1 wherein said non-destructive evaluation data comprises non-destructive evaluation data obtained by optical methods.

4. The system of claim 1 wherein said non-destructive evaluation data comprises non-destructive evaluation data obtained by visual methods.

5. The system of claim 1 wherein said deterministic non-destructive evaluation predictions and recommendations based on said strength-to-indication correlation are obtained using programmed correlations and look-up tables.

6. The system of claim 5 wherein said look-up tables comprise a non-destructive evaluation analytical look-up table.

7. The system of claim 5 wherein said look-up tables comprise a strength/load-carrying capacity-indication look-up table.

8. The system of claim 5 wherein said look-up tables comprise a safety standards look-up table.

9. A deterministic non-destructive evaluation method for composite damage assessment and repair, comprising:
providing a structure;
generating non-destructive evaluation data of said structure;
generating strength-to-indication correlations and deterministic non-destructive evaluation results based on finite element analysis performed on a structural model modified by said non-destructive evaluation data; and
recommending a move-forward response based on said strength-to-indication correlations and deterministic non-destructive evaluation results.

10. The method of claim 9 further comprising obtaining mechanical data by performing mechanical strength testing on said structure and wherein said generating strength-to-indication correlations comprises generating strength-to-indication correlations based on said mechanical data.

11. The method of claim 9 wherein said providing a structure comprises providing a composite structure.

12. The method of claim 9 wherein said generating non-destructive evaluation data of said structure comprises generating non-destructive evaluation data of said structure by ultrasonic methods.

13. The method of claim 9 wherein said generating non-destructive evaluation data of said structure comprises generating non-destructive evaluation data of said structure by optical methods.

14. The method of claim 9 wherein said generating non-destructive evaluation data of said structure comprises generating non-destructive evaluation data of said structure by visual methods.

15. The method of claim 9 wherein said recommending a move-forward response with respect said structure based on said strength-to-indication correlations and deterministic non-destructive evaluation results comprises recommending repair of said structure.

16. The method of claim 15 further comprising repairing said structure and performing non-destructive evaluation of a repair of said structure.

17. A deterministic non-destructive evaluation method for composite damage assessment and repair, comprising:
providing a structure;
generating non-destructive evaluation data of said structure;
analyzing said non-destructive evaluation data of said structure;
generating mechanical data by performing mechanical testing on said structure;
performing finite element analysis on a structural model modified by said non-destructive evaluation data and said mechanical data;
generating strength-to-indication correlations and deterministic non-destructive evaluation results based on said finite element analysis;
inputting said strength-to-indication correlations and deterministic non-destructive evaluation results to input analysis tools; and
recommending a move-forward response based on said strength-to-indication correlations and deterministic non-destructive evaluation results.

18. The method of claim 17 wherein said providing a structure comprises providing a composite structure.

19. The method of claim 17 wherein said generating non-destructive evaluation data of said structure comprises generating non-destructive evaluation data of said structure by at least one of ultrasonic methods, optical methods and visual methods.

20. The method of claim 17 wherein said generating strength-to-indication correlations and deterministic non-destructive evaluation results comprises generating strength-to-indication correlations and deterministic non-destructive evaluation results using a non-destructive evaluation analytical look-up table, a strength/load-carrying capacity-indication look-up table and a safety standards look-up table.

21. A deterministic non-destructive evaluation system for composite damage assessment and repair, comprising:
a composite structure of interest;
non-destructive evaluation data obtained by at least one of optical methods, ultrasonic methods and visual methods;
strength test data obtained on said structure of interest by mechanical testing of said structure of interest;
finite element analysis performed on a structural model modified by said non-destructive data and said strength test data;
a strength-to-indication correlation based on said finite element analysis; and
deterministic non-destructive evaluation predictions and recommendations based on said strength-to-indication correlation obtained using programmed correlations and a non-destructive evaluation analytical look-up table, a strength/load-carrying capacity-indication look-up table and a safety standards look-up table.

22. A deterministic non-destructive evaluation method for composite damage assessment and repair, comprising:
providing a composite structure;
generating non-destructive evaluation data of said composite structure by at least one of ultrasonic methods, optical methods and visual methods;
analyzing said non-destructive evaluation data of said composite structure;
generating mechanical data by performing mechanical testing on said composite structure;
performing finite element analysis on a structural model modified by said non-destructive evaluation data and said mechanical data;
generating strength-to-indication correlations and deterministic non-destructive evaluation results based on said finite element analysis using a non-destructive evaluation analytical look-up table, a strength/load-carrying capacity-indication look-up table and a safety standards look-up table;
inputting said strength-to-indication correlations and deterministic non-destructive evaluation results to input analysis tools; and
recommending a move-forward response with respect to damage of said structure based on said strength-to-indication correlations and deterministic non-destructive evaluation results.
